(19) United States
(12) Patent Application Publication
(10) Pub. No.: US 2013/0161021 A1
(43) Pub. Date: Jun. 27, 2013

(54) COMPRESSION COUPLING FOR PIPES SUBJECTED TO TENSION LOADS AND ASSOCIATED METHODS

(71) Applicants: Stephen J. Makosey, Export, PA (US); Daniel B. Bergstrom, Sarver, PA (US); K. Rao Vemuri, Murrysville, PA (US); Stephen M. Wallace, Lower Burrell, PA (US); Donald W. Millard, Apollo, PA (US)

(72) Inventors: Stephen J. Makosey, Export, PA (US); Daniel B. Bergstrom, Sarver, PA (US); K. Rao Vemuri, Murrysville, PA (US); Stephen M. Wallace, Lower Burrell, PA (US); Donald W. Millard, Apollo, PA (US)

(21) Appl. No.: 13/336,285

(22) Filed: Dec. 23, 2011

(51) Int. Cl. E21B 17/01; B23P 11/00; F16L 19/065

(52) U.S. Cl. 166/345; 285/334.2; 29/525.01

(57) ABSTRACT

A riser system for underwater oil and gas wells features subsections with flanges that may be fastened together. Riser pipes extend between the flanges, through apertures with tapered seats. The riser pipes may be may from aluminum to reduce the weight of the riser system and may be a composite of two or more sections coupled together by compression fittings.

### FIELD

The present invention relates to the connection of shorter length pipes to form a longer assembly, and more particularly, to the connection of extruded aluminum pipes that are subjected to high magnitude cyclic tensile and pressure loads.

### BACKGROUND

Some piping systems are subjected to high magnitude tensile loads and internal pressures that are cyclic in nature. This creates stresses and strains that may lead to material fatigue. For example, risers are large-diameter pipes which connect an oil drilling rig to oil well equipment on the ocean floor and that conduct well contents, e.g., liquids, gases, debris, etc. from the well to the oil rig. Some risers are made from flanged subsections and have smaller auxiliary pipes, e.g., for conducting fluids to operate controls on or near the riser, such as riser kill and choke lines. The auxiliary pipes run parallel to and are disposed about the perimeter of a larger, main pipe. Auxiliary pipes can be subjected to high pressures and varying tensile loads. Steel is the most widely used material for riser systems because steel pipes can be welded or threaded together efficiently without a significant loss in strength. Notwithstanding, steel is quite heavy, making it more difficult to handle and transport, e.g., on drill ships. The mass of the riser system also places limits on its length and subsequently, the maximum drilling depth.

Extruded aluminum pipes could potentially be used as a replacement for steel, thereby allowing deeper drilling and increased riser storage on drill ships, however, aluminum pipe made from high strength 7000 series alloys is difficult to fusion weld using conventional techniques. Threaded connections tend to have high stresses at the thread roots during loading, making them more susceptible to fatigue failure. Threaded connections also sometimes require polymer seals to maintain pressure within the pipes and to keep contaminants from entering the threads, as contamination and corrosion of the threads exacerbates material fatigue.

### SUMMARY

An embodiment of the present invention features a riser pipe having first and second sections of pipe. A socket portion having an internal peripheral tapered seat disposed at one end is coupled to the first section of pipe proximate an end thereof. A collar portion having an internal diameter permitting the collar portion to be slipped over an end of a least one of the first and second sections of pipe has an internal peripheral tapered seat disposed at one end thereof. The socket and collar portions are coaxially couplable by at least one threaded fastener, the threaded fastener drawing the socket and collar portions together when tightened. A ferrule having an outer surface sloping in opposing directions from a larger intermediate diameter to smaller diameters proximate a first end and a second end of the ferrule, can be slipped over an end of at least one of the first and second sections of pipe. The outer diameter of the second section of pipe permits an end thereof to be inserted into the socket portion with the ferrule captured between the socket portion and the collar portion and with the oppositely sloping outer surface of the ferrule engaging the tapered seats of the socket and collar portions. When the threaded fasteners draw the socket and collar together, the tapered seats of the socket and collar compress the ferrule inwardly, causing the interior surface of the ferrule to frictionally engage an outer peripheral surface of the second section of pipe. At least one of the first section of pipe and the second section of pipe is made at least partially from aluminum.

In accordance with another embodiment, the socket is integrally formed with the first section of pipe.

In accordance with another embodiment, the outside diameters of the first pipe and the second pipe are equal.

In accordance with another embodiment, the outside diameters of the first pipe and the second pipe are unequal.

In accordance with another embodiment, the riser pipe is incorporated into a riser section and at least one of the first sections of pipe and the second sections of pipe is shorter than the length of the riser section in which it is incorporated.

In accordance with another embodiment, the riser section has a terminal flange proximate each end, at least one of the terminal flanges having a through aperture with a tapered seat, at least one of the first section of pipe and the second section of pipe having a flared end that is matingly received in the tapered seat to prevent the flared end from passing through the aperture.

In accordance with another embodiment, both the first section of pipe and the second section of pipe each have a flared end that is matingly received in a corresponding tapered seat in a corresponding terminal flange.

In accordance with another embodiment, a third pipe section is conjoined to one of the first and second pipe sections.

In accordance with another embodiment, the riser pipe has more than three pipe sections.

In accordance with another embodiment, the socket has a socket collar with an internal diameter permitting the socket collar to be slipped over an end of the first section of pipe, the socket collar portion having an internal peripheral tapered seat disposed at one end thereof, the socket also having a hollow intermediate body with the internal peripheral tapered seat at one end and another peripheral tapered seat at the other end. The socket collar and the intermediate body are coaxially couplable by at least one threaded fastener, the threaded fastener drawing the socket collar and the intermediate body together when tightened. The socket has a second ferrule having an outer surface sloping in opposing directions from a larger intermediate diameter to smaller outside diameters proximate a first end and a second end of the second ferrule, the inside diameter of the second ferrule permitting the second ferrule to be slipped over an end of the first section of pipe, the outer diameter of the first section of pipe permitting an end thereof to be inserted into the hollow intermediate body with the second ferrule captured between the socket collar and the hollow intermediate body and with the oppositely sloping outer surface of the second ferrule engaging the tapered seats of the socket collar and the hollow intermediate body, such that when the threaded fastener draws the socket collar and hollow intermediate body together, the tapered seats of the socket collar and the hollow intermediate body compress the second ferrule inwardly causing an interior surface of the second ferrule to frictionally engage an outer peripheral surface of the first section of pipe.

In accordance with another embodiment, a riser system for an underwater well drilled into the earth below a body of water, the riser system extending from well equipment located near the underwater earth-water interface to a platform proximate the surface of the water has a plurality of sub-sections connected together. Each subsection has at least one riser pipe for conducting at least one fluid between the well equipment and the platform and having at least one sub-section having a composite riser pipe having a plurality of sub-lengths conjoinable by at least one compression fitting.

In accordance with another embodiment, the composite riser pipe is made at least partially of aluminum.

In accordance with another embodiment, the number of sub-lengths is greater than two and the conjunction of each sub-length to the next is made by a compression fitting.

In accordance with another embodiment, each sub-length of the composite riser pipe is made at least partially of aluminum.

In accordance with another embodiment, each riser section has a flange proximate each end, each flange having at least one aperture therein and wherein a sub-length of the composite riser pipe extends through an aperture in each of the flanges, each of the two sub-lengths of composite riser pipe extending through the apertures having a flared end receivable in and mating with the tapered seat in the corresponding flange.

In accordance with another embodiment, an end of the two sub-lengths opposite the flared end inserts into a compression fitting.

In accordance with another embodiment, a method for forming a sub-section of a riser system, the subsection having a pair of flanges proximate the ends thereof; at least one flange having an aperture with a tapered seat, includes obtaining a first riser pipe having a flared end capable of being matingly received in the tapered seat of the flange; obtaining a compression fitting capable of slidably receiving an end of the first riser pipe opposite to the flared end thereof, the compression fitting coupled to a second length of riser pipe extending to the other flange of the pair of flanges; sliding the first riser pipe through the aperture, such that the flared end is matingly received in the tapered seat and the opposite end is received in the compression fitting; and tightening the compression fitting to grip the first riser pipe.

In accordance with another embodiment, both of the pair of flanges have apertures with tapered seats and the second riser pipe has a flared end and an end slidably receivable in a compression fitting and further including the step of sliding the second riser pipe through a corresponding aperture in the second of the pair of flanges, such that the flared end thereof is matingly received in the tapered seat of the second flange and sliding the other end of the second riser pipe into a compression fitting and tightening the compression fitting to grip the second riser pipe.

In accordance with another embodiment, the first and second riser pipes are both slidably receivable in the same compression fitting.

In accordance with another embodiment, at least one intermediate riser pipe is obtained, both ends of which are slideably receivable in a corresponding compression fitting. Each of the ends of the at least one intermediate pipe are inserted into the corresponding compression fittings, the corresponding compression fittings coupling to the first and second riser pipes.

### BRIEF DESCRIPTION OF THE DRAWINGS

For a more complete understanding of the present invention, reference is made to the following detailed description of exemplary embodiments considered in conjunction with the accompanying drawings.

FIG. 1 is a perspective view of a section of a well riser.

FIG. 2 is a cross sectional view of a section of well riser in accordance with an exemplary embodiment of the present disclosure.

FIG. 3 is an enlarged view of a threaded fitting for an auxiliary riser pipe.

FIG. 4 is a cross-sectional view of a pipe coupling in accordance with an embodiment of the present disclosure.

FIG. 5 is an enlarged view of a fragment of the pipe coupling of FIG. 4.

FIG. 6 is an exploded perspective view of a pipe coupling in accordance with another embodiment of the present disclosure.

FIG. 7 is a cross sectional view of the pipe coupling of FIG. 6 in an assembled state.

### DETAILED DESCRIPTION OF EXEMPLARY EMBODIMENTS

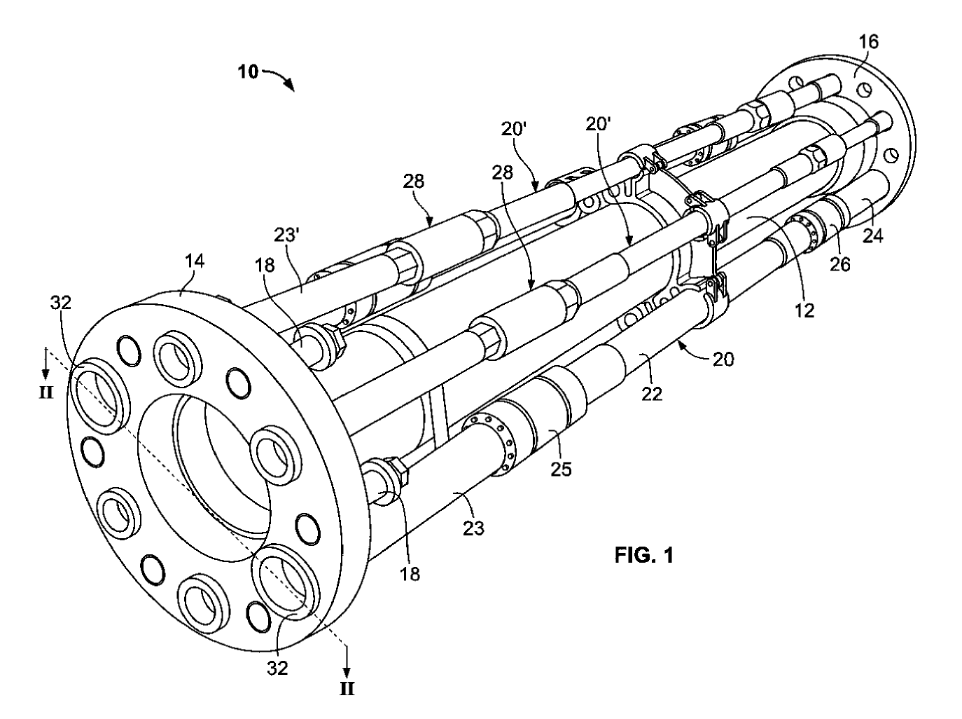

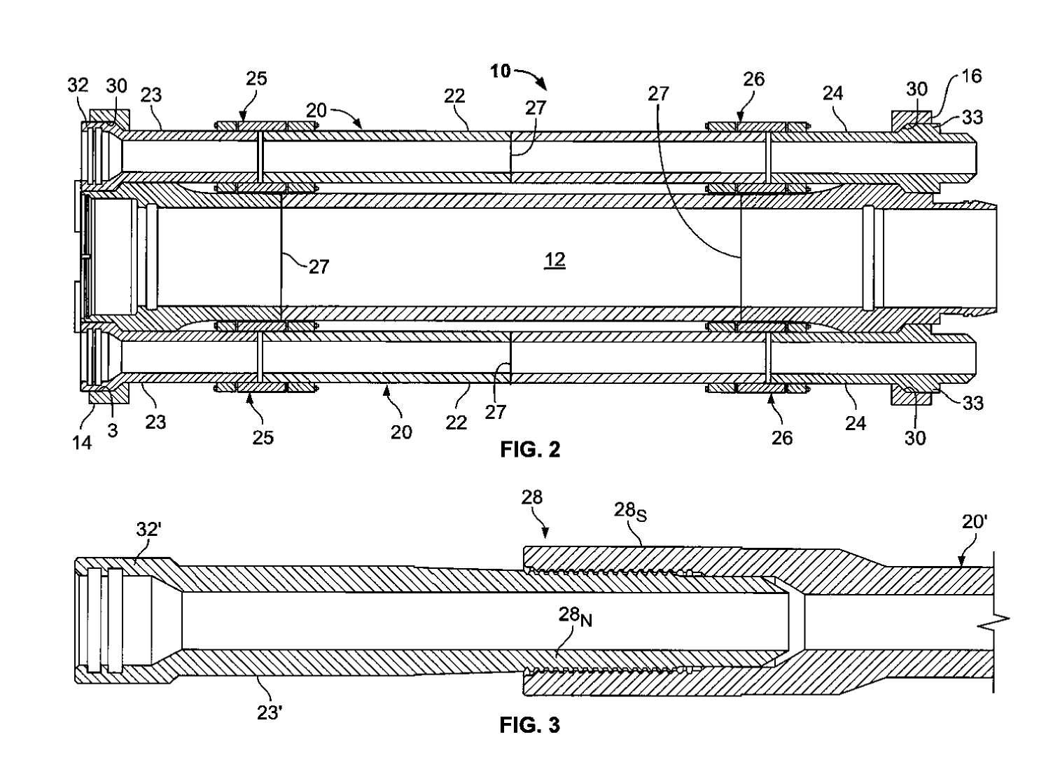

FIGS. 1 and 2 show a riser section 10 having a main pipe 12 extending between two flanges 14, 16, which allow adjacent, similar riser sections 10 to be connected together using, e.g., a plurality of bolts 18 and mating nuts (not shown) to form an elongated riser that can be utilized to connect an oil well platform at the surface of the sea to a well head or well casing on the sea floor. A plurality of peripheral auxiliary pipes 20, 20′ extend between the flanges 14, 16 and are used for various functions, such as for controlling well head apparatus, injecting or withdrawing various fluids communicating between the well head and the oil platform, for riser choke and kill lines, etc. in accordance with the present disclosure, the auxiliary pipes 20 may have an intermediate portion 22 conjoined to end portions 23, 24 via one or more compression couplings 25, 26, that shall be described fully below. The intermediate portion 22 may be formed with one or more weld joints 27 and/or any given number of sub-sections, e.g., like subsections 22, 23, 24 joined by compression couplings like, e.g., couplings 25, 26. The end portions 23, 24 may be extended through tapered apertures 30 in the respective flanges 14, 16 and then received into the couplings 25, 26 to join to the intermediate portion 22. A tapered or flanged head 32, 33 of the end portions 23, 24 may be utilized to matingly engage a mating tapered aperture 30. The flanges 14, 16 are held at a fixed relative distance by the main pipe 12, which may be fabricated from welded portions, as shown by the weld lines 27. As shown in FIG. 1, the opposite ends of the main pipe 12 and the auxiliary pipes 20 may be provided with male and female terminations and fitted with seals to form a complementary, fluid tight connection between adjacent riser sections 10. In accordance with conventional methods, auxiliary pipes 20′ may be fabricated from sub-sections using threaded connections 28.

FIG. 3 shows an enlarged view of a threaded fitting 28 having a socket portion 28_{S} and a nipple portion 28_{N}, The nipple portion 28_{N} can be utilized to terminate a pipe like pipe 23′ in order to connect to socket 28_{S}. Seals or sealing compound may be required to maintain a fluid-tight junction established by the threaded fitting 28 to maintain pressure in the auxiliary tube 20′ and to avoid contamination and/or corrosion of the threaded components 28_{N}, 28_{S}. As noted, the threads in the socket 28_{S} and on the nipple 28_{N} act as stress risers when exposed to cyclic tension, e.g., due to the oscillation of the riser and riser sections 10 attributable to movement of the oil well platform in response to ocean waves, currents, wind, etc. and are subject to metal fatigue from this cyclic loading. As a result, auxiliary pipes utilizing threaded o couplings are more prone to metal fatigue than the auxiliary pipes 20 which utilize compression couplings 25, 26 in accordance with the present disclosure. Due to the increased likelihood of fatigue at the threads of threaded couplings, such threaded couplings are preferably made from steel, rather than aluminum.

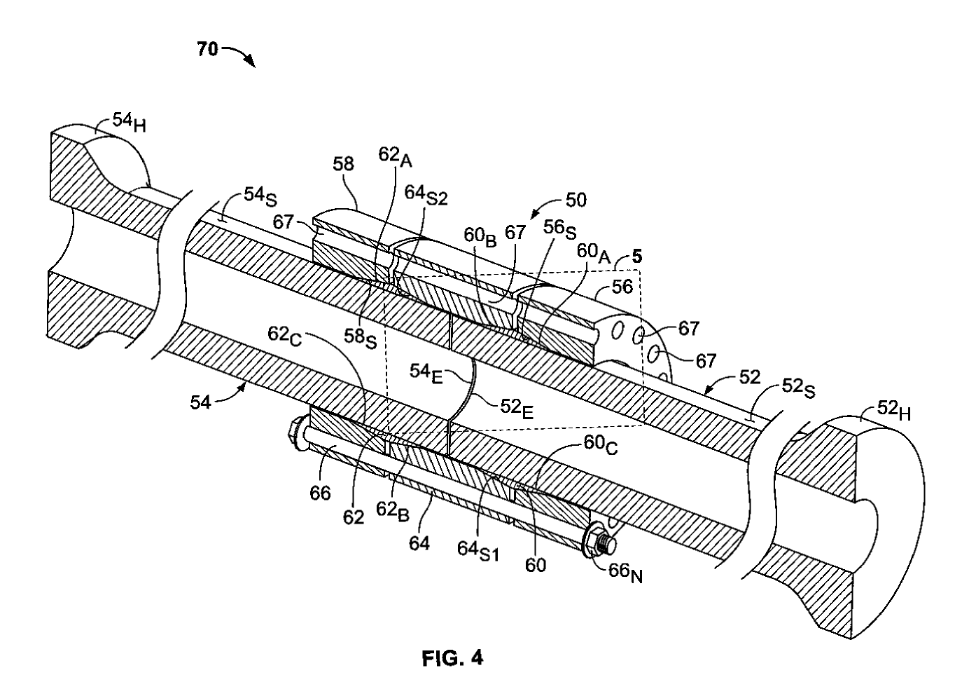

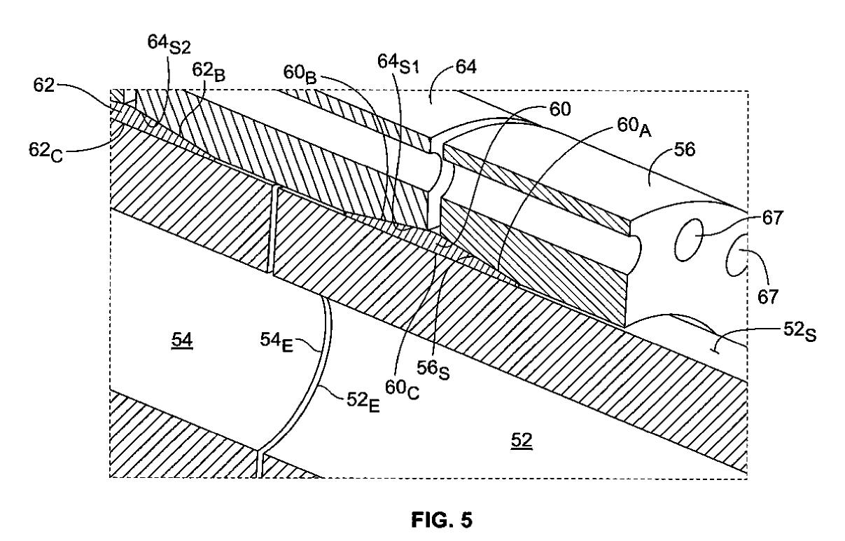

FIGS. 4 and 5 show a coupling 50 for joining two pipes 52, 54 in an end-to-end or generally abutting orientation to yield an auxiliary pipe 70. Coupling 50 would therefore be suitable for use for couplings 25 and 26 in the riser section 10 shown in FIGS. 1 and 2. As shall be evident from the following disclosure, it is not necessary that the ends 52_{E}, 54_{E} contact one another. The pipes 52, 54 may be made of any material, e.g., steel or aluminum and may be made of different materials, e.g., pipe 52 may be aluminum and pipe 54 may be steel. The coupling 50 has a pair of end collars 56, 58 that slip over the ends 52_{E}, 54_{E} of respective pipes 52, 54. The end collars 56, 58 each have tapered seats 56_{S}, 58_{S} that wedge against tapered surfaces 60_{A}, 62_{A} of a pair of ferrules 60, 62, respectively. A center collar 64 has a pair of seats 64_{S1}, 64_{S2} which slip over tapered surfaces 60_{B}, 62_{B} of the ferrules 60, 62, respectively, pushing the bottom surfaces, 60_{C}, 62_{C} of the ferrules 60, 62 into close frictional engagement with the outer surfaces, 52_{S} 54_{S} of pipes 52, 54.

The coupling 50 is assembled by sliding an end collar 56, 58 over the ends 52_{E}, 54_{E} of respective pipes 52, 54. A ferrule 60, 62 is then slid over the ends 52_{E}, 54_{E} of respective pipes 52, 54. A center collar 64 is then positioned between the pipes 52, 54 and the ends 52_{E}, 54_{E} are inserted into the center collar 64, such that the pipes 52, 54 are approximately abutting at the approximate middle of the axial length of the central collar 64. The end collars 56, 58 are then drawn towards the central collar 64, sliding the ferrules 60, 62 toward the central collar 64. Through bolts 66 extending through openings in the end collars 56, 58 and the central collar 64, receive mating nuts 66_{N}, which together clamp the coupling 50 together in compression. As the bolts 66 and nuts 66_{N} are tightened, the ferrules 60, 62 are compressed axially and radially and converge radially inwardly towards the outer surfaces 52_{S}, 54_{S} of the pipes 52, 54. These combined actions provide a rigid, fluid-tight connection of the pipes 52, 54, in that surfaces 60_{A}, 60_{B}, 60_{C} of the ferrule 60 seal against the tapered seat 56s, the tapered seat 64_{S1} and the outer surface 52_{S} of the pipe 52, respectively, and the surfaces 62_{A}, 62_{B}, 62_{C} of the ferrule 62 seal against the tapered seat 58s the tapered seat 64_{S2} and the outer surface 54_{S} of the pipe 54, respectively. The radially inwardly directed compressive forces exerted on the ferrules 60, 62 create a strong frictional interaction between the ferrules 60, 62 and the pipes 52, 54 that strongly resists pulling the pipes 52, 54 apart/out of the coupling 50 when the pipes 52, 54 are pulled in a tensioning direction. The pipes 52, 54 may be provided with a tapered head 52_{H} and 54_{H}, respectively, that can engage a tapered seat in a flange of a riser section, such as tapered aperture 30 in flange 12 or 14 of riser section 10 shown in FIGS. 1 and 2 The tapered heads 52_{H} and 54_{H}, may feature internal machined surfaces to receive seals and otherwise seal the junction between an adjacent tapered head 52_{H} and 54_{H}, of an adjacent riser section 10.

To assemble an auxiliary pipe 70 in a riser section like riser section 10 of FIG. 1, the two pipe sections 52 and 54 are each slid through corresponding tapered apertures 30 in the flanges 14, 16 and the ends 52_{E}, 54_{E} are received in the coupling 50. When the tapered ends 52_{H}, 54_{H} bottom out in the tapered apertures 30 in the flanges 14, 16, the coupling 50 can be tightened, as described above, hydraulically and mechanically unifying the pipes 52, 54. It should be observed that the coupling 50 can be used between any selected number of pipe subsections, such that an auxiliary pipe 70 can be composed of subsections of smaller (and more numerous) or larger (and less numerous) lengths. This ability to control the lengths of pipe subsections may be used to adapt the auxiliary pipe 70 to a given workspace. More particularly, if a ship has a work room for disassembling and replacing auxiliary pipes 20 from riser sections 10, long lengths of auxiliary pipe 20 may exceed the dimensions of the workspace when they are withdrawn from the flange 14, 16 of a riser section 10. The same type of operating clearances would be a consideration when re-assembling the riser section 10. The ability to subsection the auxiliary pipe 70 into smaller lengths permits the auxiliary pipe 70 to be disassembled from the riser section 10 and re-assembled in less space.

The coupling 50 and the pipes 52, 54 may be made from a variety of materials, e.g., steel or aluminum and may be made of the same material or may be of different materials, e.g., pipe 52 may be steel and pipe 54 may be aluminum or vice versa. The ferrules 60, 62 may be made of a variety of materials, e.g., steel, aluminum, titanium, copper, bronze, brass or other metals and alloys thereof. It may be beneficial for the ferrules 60, 62 to be made from a material that could permanently deform when the coupling 50 is tightened, to more evenly distribute the pressure between the ferrules 60, 62 and the pipes 52, 54. It may also be preferable for the combination of materials chosen for the pipes 52, 54 and the ferrules 60, 62 to exhibit a high degree of relative sliding friction. For example, an aluminum-to-aluminum or an aluminum-to-stainless steel interface may result in a high level of frictional interaction and therefore be capable of withstanding a high level of shear traction.

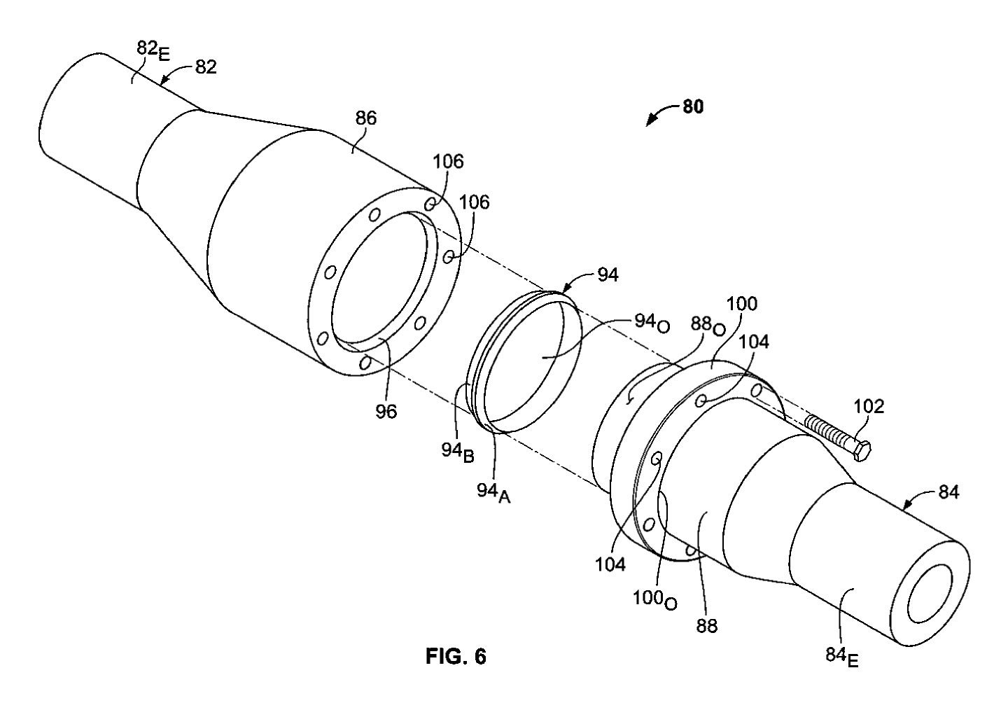

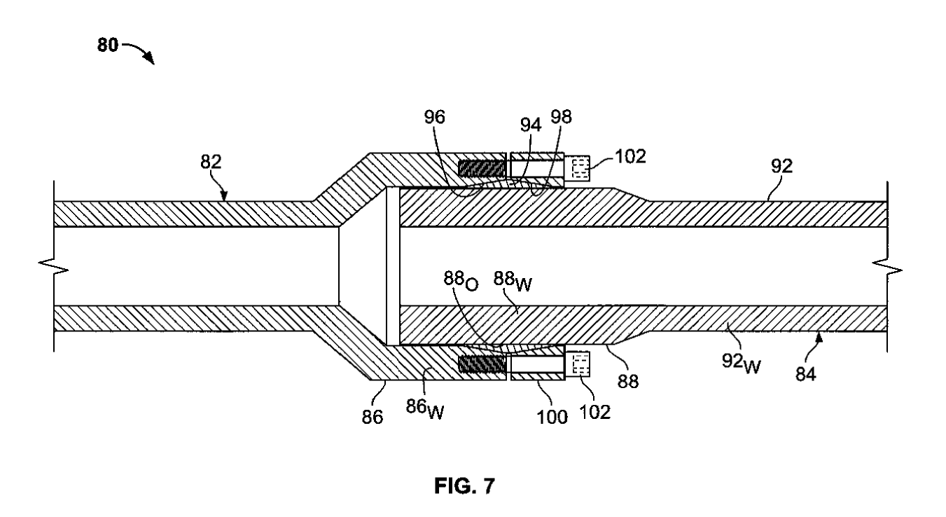

FIGS. 6 and 7 show a pipe coupling 80 between a first pipe 82 and a second pipe 84. Either the first pipe 82 or the second pipe 84 could be internally threaded at the ends 82_{E}, 84_{E} thereof, or could be smooth as shown, to be accommodated within a coupling, like coupling 50 shown in FIG. 4. For example, the first pipe 82 could be a machined fitting with internal threads to receive a threaded nipple, like nipple 28_{N} of FIG. 3. In that case, first pipe 82 could be described as a machined terminal fitting, like socket 28_{S} shown in FIG. 3. Alternatively, the ends 82_{E} and/or 84_{E} could be accommodated in a coupling, like coupling 50 of FIG. 4, slipping into an end collar, like collar 56, receiving a ferrule, like ferrule 60 there over and inserting into a center collar like center collar 64 of FIG. 4 to form a larger pipe assembly, such as, for an auxiliary pipe. Coupling 80 may be used intermediate two couplings 50 to provide an intermediate length of piping. While pipes 82 and 84 are depicted as being short, they could be any desired length.

The pipes 82, 84 may be made from a variety of materials, e.g., steel or aluminum and may be made of the of same material or may be of different materials, e.g., pipe 82 may be steel and pipe 84 may be aluminum or vice versa. In the pipe coupling 80 shown, the first pipe 82 has an enlarged socket end 86 that flares out to form a socket for receiving an end 88 of the second pipe 84 in a slip-fit relationship. The end 88 of the second pipe 84 has walls 88w which are thicker than the walls 92_{W} of the remainder 92 of the pipe 84, a configuration which may be formed by upset during the extrusion process. The relatively thicker walls 88w concentrate material at the coupling 80 to promote the strength of the coupling 80. The thickness of the walls 86w, 88w may be determined based upon the forces anticipated to be exerted on the coupling and adjusted up or down based upon requirements. A ferrule 94 with opening 94_{O} slips over the end 88 of the second pipe 84. The ferrule 94 is captured between three surfaces, viz., a tapered seat 96 formed on the interior periphery of the socket end 86, a tapered seat 98 formed on the interior periphery of a collar 100, and the outer peripheral surface 88_{O} of the end 88 of the second pipe 84. The opening 94_{O} has an internal diameter approximating the external diameter of end 88, allowing the ferrule 94 to be moved by hand over the end 88. The collar 100 has an opening 100_{O} with an internal diameter approximating the external diameter of the end 88, such that the collar 100 may be moved by hand on the end 88.

To form the coupling 80, the end 88 is inserted into the socket end 86. The collar 100 is then secured to the socket end 86 by a plurality of machine screws 102 that slip through mating apertures 104 in the collar 100 and thread into threaded apertures 106 formed in the walls 86w of the socket end 86. The ferrule 94 has opposed tapered surfaces 94_{A}, 94_{B} on either side, allowing the tapering seats 96, 98 to override the tapered surfaces 94_{A}, 94_{B} of the ferrule 94, pressing the ferrule 94 radially inwardly toward the outer surface 88_{O} of the end 88 of the second pipe 84, as the collar 100 is pulled closer to the socket end 86 by tightening the screws 102. This action creates a high magnitude interface pressure between the ferrule 94 and the pipe 84. Due to friction, the interface between the ferrule 94 and the pipe 84 can support a shear traction that will keep the pipe from pulling out of the socket while loading the joint 80 in tension. The ferrule 94 may be made of a variety of materials, e.g., steel, aluminum, titanium, copper, bronze, brass or other metals and alloys thereof. The outer diameter of piping used with a coupling like coupling 50, 80 in accordance with the present disclosure may be trued by machining and/or burnished. The peak tensile stress in a compression coupling 50, 80 in accordance with the present disclosure is on the outside of the pipes, e.g., 52, 54 (FIG.4) joined, which may be burnished to create a counteracting compressive stress. A smooth pipe is relatively easier to burnish than the components of a threaded coupling, in particular, at internal thread roots.

Testing of a coupling 50, 80 under tensile load shows that the peak maximum stress (adjacent to a ferrule, e.g., 60), is substantially less that the peak maximum stress. experienced by a threaded coupling (at the last thread of a threaded coupling) for similarly sized piping systems under approximately the same load. This is due to the lack of large circumferential threads to act as stress risers. The ferrule 60, 62, 94 applies compressive and shear traction to the exterior of the pipe 52, 54, 84 (at 88). Finite element analysis shows that the peak stress in a threaded coupling subjected to a tensile load is at least 110% higher than the nominal stress in a pipe with 5 inch O.D.×3 inch I.D. In a similar pipe using a coupling according to the present disclosure, the peak stress is only 30% higher than the nominal stress. As a result, a sample coupling according to the present disclosure using pipe formed from 6061-T6 aluminum alloy was able to undergo more testing cycles than threaded designs of similarly dimensioned pipe made with C22N aluminum alloy, an alloy with superior high cycle fatigue resistance to that of the 6061-T6 alloy.

In a test of a coupling in accordance with the present disclosure, such as shown in FIGS. 4 and 5, a pipe-to-pipe coupling was fatigue tested by cyclic loading. The pipes were made from 6061-T6 aluminum alloy and had dimensions 5.995 inches O.D., 3 inches I.D. The coupling collars were made from 4340 steel. The ferrules were made from 6061-T6 aluminum alloy and had an initial I.D. of 6.000 inches, a maximum O.D. of 6.6 inches and a minimum O.D. of 6.1 inches. The angle between the inner surfaces and the sloped faces of the ferrules taken along an axial direction was about 10 degrees. The seats of the center and end collars were oriented relative to the bore there of at an angle of 170 degrees, which was complementary to the sloped ferrule face angle. The length of the sloped ferrule face taken in an axial direction was about 1.375 inches. The length of the seat face of the center and end collars was about 1.5 inches. A total of eighteen ⅝ inch 24 tpi Grade 8 fasteners torqued to 150 ft. lbs. were used to compress the coupling. The fatigue testing was conducted on the coupling with loads varying between 125,000 to 250,000 pounds at the rate of 7 transitions per minute. This cyclic loading was conducted until the point of failure of 1,364,948 cycles.

The use of a coupling in accordance with the present disclosure as depicted in FIGS. 4 and 5 does not require welding of the piping system at the coupled joint. Welding can detrimentally affect structural and corrosion performance and also represents an energy intensive, additional fabrication step which adds to the cost of the welded product.

It is understood that the embodiments described herein are merely exemplary and that a person skilled in the art may make many variations and modifications without departing from the spirit and scope of the claimed subject matter. For example, FIGS. 4 and 5 show a coupling 50 that joins pipes 52, 54 having similar outer diameters and with the central collar 64 having a generally cylindrical configuration. Alternatively, the central collar 64 could have a flared configuration, such that one side could accommodate a pipe 54 having a greater outer diameter than pipe 52. While a symmetrical ferrule having faces sloped at 10 degrees was described above, the slope angle may be varied and the oppositely sloped faces of the ferrule may have different slope angles. When installing the ferrule on a pipe, differential heating/cooling of the ferrule and the pipe may facilitate sliding the ferrule on the pipe. For example, the ferrule may be heated and/or the pipe may be cooled. As shown in FIG. 1, a compression coupling, e.g., coupling 25, 26 in accordance with the present invention may be utilized to form an auxiliary pipe 20 from aluminum in a riser system 10 that also includes steel pipe with threaded fittings 28. The compression couplings 25, 26, 50, 80 disclosed in the present invention may be utilized in forming a center pipe 12 of a riser system 10. While the present disclosure utilizes a riser system as an exemplary environment in which the present invention may be practiced, other piping applications requiring resistance to cyclic loading and tension or stress would be also be appropriate. All such variations and modifications are intended to be included within the scope of the appended claims.

We claim:

1. A riser pipe, comprising:
a first section of pipe;
a second section of pipe;
a socket portion having an internal peripheral tapered seat disposed at one end, the socket portion coupled to the first section of pipe proximate an end thereof;
a collar portion having an internal diameter permitting the collar portion to be slipped over an end of a least one of the first and second sections of pipe, the collar portion having an internal peripheral tapered seat disposed at one end thereof, the socket and collar portions being coaxially couplable by at least one threaded fastener, the threaded fastener drawing the socket and collar portions together when tightened;
a ferrule having an outer surface sloping in opposing directions from a larger intermediate diameter to smaller diameters proximate a first end and a second end of the ferrule, the internal is diameter of the ferrule permitting the ferrule to be slipped over an end of at least one of the first and second sections of pipe, the outer diameter of the second section of pipe permitting an end thereof to be inserted into the socket portion with the ferrule captured between the socket portion and the collar portion and with the oppositely sloping outer surface of the ferrule engaging the tapered seats of the socket and collar portions, such that when the threaded fastener draws the socket and collar together, the tapered seats of the socket and collar compress the ferrule inwardly causing the interior surface of the ferrule to frictionally engage an outer peripheral surface of the second section of pipe, at least one of the first section of pipe and the second section of pipe being made at least partially from aluminum.

2. The riser pipe of claim 1, wherein the socket is integrally formed with the first section of pipe.

3. The riser pipe of claim 1 wherein the outside diameters of the first pipe and the second pipe are equal.

4. The riser pipe of claim 1 wherein the outside diameters of the first pipe and the second pipe are unequal.

5. The riser pipe of claim 1, wherein the riser pipe is incorporated into a riser section and at least one of the first sections of pipe and the second sections of pipe is shorter than the length of the riser section in which it is incorporated.

6. The riser pipe of claim 5, wherein the riser section has a terminal flange proximate each end, at least one of the terminal flanges having a through aperture with a tapered seat, at least one of the first section of pipe and the second section of pipe having a flared end that is matingly received in the tapered seat to prevent the flared end from passing through the aperture.

7. The riser pipe of claim 6, wherein both the first section of pipe and the second section of pipe each have a flared end that is matingly received in a corresponding tapered seat in a corresponding terminal flange.

8. The riser pipe of claim 1, further comprising a third pipe section conjoined to one of the first and second pipe sections.

9. The riser pipe of claim 8, further comprising more than three pipe sections.

10. The riser pipe of claim 1, wherein the socket has a socket collar having an internal diameter permitting the socket collar to be slipped over an end of the first section of pipe, the socket collar portion having an internal peripheral tapered seat disposed at one end of thereof, the socket also having a hollow intermediate body with the internal peripheral tapered seat at one end and another peripheral tapered seat at the other end, the socket collar and the intermediate body being coaxially couplable by at least one threaded fastener, the threaded fastener drawing the socket collar and the intermediate body together when tightened; the socket having a second ferrule having an internal diameter and an outer surface sloping in opposing directions from a larger intermediate diameter to smaller outside diameters proximate a first end and a second end of the second ferrule, the inside diameter of the second ferrule permitting the second ferrule to be slipped over an end of the first section of pipe, the first outer diameter of the first section of pipe permitting an end thereof to be inserted into the hollow intermediate body with the second ferrule captured between the socket collar and the hollow intermediate body and with the oppositely sloping outer surface of the second ferrule engaging the tapered seat of the socket collar and the another peripheral tapered seat at the other end of the hollow intermediate body, such that when the threaded fastener draws the socket collar and hollow intermediate body together, the tapered seats of the socket collar and the hollow intermediate body compress the second ferrule inwardly causing an interior surface of the second ferrule to frictionally engage an outer peripheral surface of the first section of pipe.

11. A riser system for an underwater well drilled into the earth below a body of water, the riser system extending from well equipment located near the underwater earth-water interface to a platform proximate the surface of the water, the riser system having a plurality of sub-sections connected together, each sub-section having at least one riser pipe for conducting at least one fluid between the well equipment and the platform, comprising:
at least one sub-section having a composite riser pipe having a plurality of sub-lengths conjoinable by at least one compression fitting.

12. The riser system of claim 11, wherein the composite riser pipe is made at least partially of aluminum.

13. The riser system of claim 12, wherein the number of sub-lengths is greater than two and the conjunction of each sub-length to the next is made by a compression fitting.

14. The riser system of claim 12, wherein each sub-length of the composite riser pipe is made at least partially of aluminum.

15. The riser system of claim 11, wherein each riser section has a flange proximate each end, each flange having at least one aperture therein and wherein a sub-length of the composite riser pipe extends through an aperture in each of the flanges, each of the two sub-lengths having a flared end receivable in and mating with the tapered seat in the corresponding flange.

16. The riser system of claim 15, wherein an end of the two sub-lengths opposite the flared end inserts into a compression fitting.

17. A method for forming a sub-section of a riser system, the sub-section having a flange proximate both ends thereof, at least one flange having an aperture with a tapered seat, comprising:
(A) obtaining a first riser pipe having a flared end capable of being matingly received in the tapered seat of the flange;
(B) obtaining a compression fitting capable of slidably receiving an end of the first riser pipe opposite to the flared end thereof, the compression fitting coupled to a second length of riser pipe extending to the other flange of the sub-section;
(C) sliding the first riser pipe through the aperture, such that the flared end is matingly received in the tapered seat and the opposite end is received in the compression fitting;
(D) tightening the compression fitting to grip the first riser pipe.

18. The method of claim 17, wherein both of the flanges have apertures with tapered seats and wherein the second riser pipe has a flared end and an end slidably receivable in a compression fitting and further comprising the step of sliding the second riser pipe through a corresponding aperture in the second of the pair of flanges, such that the flared end thereof is matingly received is in the tapered seat of the second flange and sliding the other end of the second riser pipe into a compression fitting and tightening the compression fitting to grip the second riser pipe.

19. The method of claim 18, wherein the first riser pipe and the second riser pipe are both slidably receivable in the same compression fitting.

20. The method of claim 18, further comprising the steps of obtaining at least one intermediate riser pipe, both ends of which are slideably receivable in a corresponding compression fitting and the step of inserting each of the ends of the intermediate pipe into the corresponding compression fittings and tightening the corresponding compression fittings to grip the intermediate pipe, the corresponding compression fittings coupling to the first and second riser pipes.
